(19) United States
(12) Patent Application Publication
(10) Pub. No.: US 2023/0071394 A1
(43) Pub. Date: Mar. 9, 2023

(54) Systems and Methods for Cyber-Fault Detection

(71) Applicant: GENERAL ELECTRIC COMPANY, Schenectady, NY (US)

(72) Inventors: Subhrajit ROYCHOWDHURY, Cohoes, NY (US); Masoud ABBASZADEH, Clifton Park, NY (US); Georgios BOUTSELIS, Niskayuna, NY (US); Joel MARKHAM, Niskayuna, NY (US)

(73) Assignee: GENERAL ELECTRIC COMPANY, Schenectady, NY (US)

(21) Appl. No.: 17/406,205

(22) Filed: Aug. 19, 2021

(51) Int. Cl. G05B 23/02; G06F 16/23; G08B 29/18

(52) U.S. Cl. CPC G05B 23/0243; G06F 16/2365; G08B 29/185; H03M 7/30

(57) ABSTRACT

The present disclosure relates to techniques for detecting cyber-faults in industrial assets. Such techniques may include obtaining an input dataset from a plurality of nodes of industrial assets and predicting fault nodes in the plurality of nodes by inputting the input dataset to a one-class classifier. The one-class classifier may be trained on normal operation data obtained during normal operations of the industrial assets. Further, the cyber-fault detection techniques may include computing a confidence level of cyber fault detection for the input dataset using the one-class classifier and adjusting decision thresholds based on the confidence level for categorizing the input dataset as normal or including cyber-faults. The predicted fault nodes and the adjusted decision thresholds may be used for detecting cyber-faults in the plurality of nodes of the industrial assets.

### TECHNICAL FIELD

The disclosed implementations relate generally to cyber-physical systems and more specifically to systems and methods for cyber-fault detection in cyber-physical systems.

### BACKGROUND

Performance of traditional cyber-fault detection systems for industrial assets depend on availability of high definition simulation models and/or attack data. Conventional detection methods for cyber-faults in industrial assets cast the detection problem as a two-class or multi-class classification problem. Such systems use significant amount of normal and attack data generated from high definition simulation models of the asset to train the classifier to achieve high prediction accuracy. However, these techniques have limited use when the attack data is limited or unavailable, or when no simulation model is available to generate attack data.

### SUMMARY

Accordingly, there is a need for systems and methods for detection of cyber-faults (cyber-attacks and system faults) with high accuracy in industrial assets in such scenarios. In one aspect, some implementations include a computer-implemented method for implementing a one-class classifier to detect cyber-faults. The one-class classifier may be trained only using normal simulation data, normal historical field data, or a combination of both. In some implementations, to boost the detection accuracy of the one-class system, an ensemble of detection models for different operating regimes or boundary conditions may be used along with an adaptive decision threshold based on the confidence of prediction.

In one aspect, some implementations include a computer-implemented method for detecting cyber-faults in industrial assets. The method may include obtaining an input dataset from a plurality of nodes (e.g., sensors, actuators, or controller parameters) of industrial assets. The nodes may be physically co-located or connected through a wired or wireless network (in the context of IoT over 5G, 6G or Wi-Fi 6). The nodes need not be collocated for applying the techniques described herein. The method may also include predicting a fault node in the plurality of nodes by inputting the input dataset to a one-class classifier. The one-class classifier may be trained on normal operation data (e.g., historical field data or simulation data) obtained during normal operations (e.g., no cyber-attacks) of the industrial assets. The method may further include computing a confidence level of cyber fault detection for the input dataset using the one-class classifier. The method may also include adjusting a decision threshold based on the confidence level for categorizing the input dataset as normal or including a cyber-fault. The method may further include detecting the cyber-fault in the plurality of nodes of the industrial assets based on the predicted fault node and the adjusted decision threshold.

In another aspect, a system configured to perform any of the methods described in this disclosure is provided, according to some implementations.

In another aspect, a non-transitory computer-readable storage medium has one or more processors and memory storing one or more programs executable by the one or more processors. The one or more programs include instructions for performing any of the methods described in this disclosure.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 shows a block diagram of an example system for detecting cyber-faults in industrial assets, according to some implementations.

FIG. 2 is a schematic showing various components of a system for detecting cyber-faults in industrial assets, according to some implementations.

FIG. 3 shows a block diagram of an example system for adaptive neutralization of cyber-attacks, according to some implementations.

FIG. 4 shows a flowchart of an example method for self-adapting neutralization against cyber-faults for industrial assets, according to some implementations.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first electronic device could be termed a second electronic device, and, similarly, a second electronic device could be termed a first electronic device, without departing from the scope of the various described implementations. The first electronic device and the second electronic device are both electronic devices, but they are not necessarily the same electronic device.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Cyber-fault attack data is rare in field. On top of that, generating abnormal dataset of cyber-attacks and system/component faults is a slow and expensive process requiring advanced simulation capabilities for the system of interest and a lot of domain knowledge. Therefore, it is essential to develop methodologies for cyber-fault detection and localization without abnormal dataset generation or simulation data altogether. For the description herein, normal data is data collected during operation of the asset that is considered ‘normal’, and attack data is data in which one or more node is manipulated. High definition simulation models are models that capture details of the nonlinear physics involved. Typically, the execution of these models may be slower than real time execution. Techniques described herein can be used to implement detection systems that are trained only on historical field data thereby eliminating dependence on availability of high definition simulation model and/or substantial amount of attack data. Another use case is when there is a high definition simulation model available, but generation of attack data is expensive both in terms of time and money. In such scenarios, if a model has to be deployed quickly, some implementations may generate a limited set of normal data to start with, and upgrade the detector as time progresses.

Some implementations use an ensemble of models for prediction of faulty nodes or nodes experiencing fault nodes depending on accuracy of different models (i) for different operating regimes (e.g., steady state, slow/fast transient, rising/falling transient and so on), and (ii) for different boundary conditions (e.g., environmental conditions such as temperature, pressure, humidity and so on). This technique boosts the true positive rate (TPR) of detection compared to that obtained with a single monolithic model.

In some implementations, as described in detail below, decision thresholds on residuals are adapted based on the confidence of prediction accuracy. Residuals are appropriate functions of the difference between ground truth and a predicted value. For a multi-variable case as in the instant case, an appropriate norm is chosen to get a simplified metric. A relatively high confidence would result in a more aggressive tuning of the decision thresholds whereas a lower confidence would adjust the tuning accordingly. This technique lowers the false positive rate (FPR) of detection by relaxing decision thresholds in region of lower confidence resulting either due to inherent lower local sensitivity of the model or due to extrapolation of boundary conditions (e.g., encountering a boundary condition which is either not within its training envelope or in a sparse region).

Some implementations use a decision playback capability that allows for reducing false alarms using persistence criteria, while feeding back the early decision to a neutralization module since the onset so that the control system is not drifted too far because of decision delay.

As stated above in the Summary section, conventional detection methods for cyber-faults in industrial assets deal with the problem as a two-class or multi-class classification problem. Significant amount of normal and attack data are generated from high definition simulation models of the asset to train the classifier to achieve high prediction accuracy. The paradigm, however, is not applicable when no/limited attack data is available, and no simulation model is available to generate enough attack data or when data generation is expensive for the problem at hand.

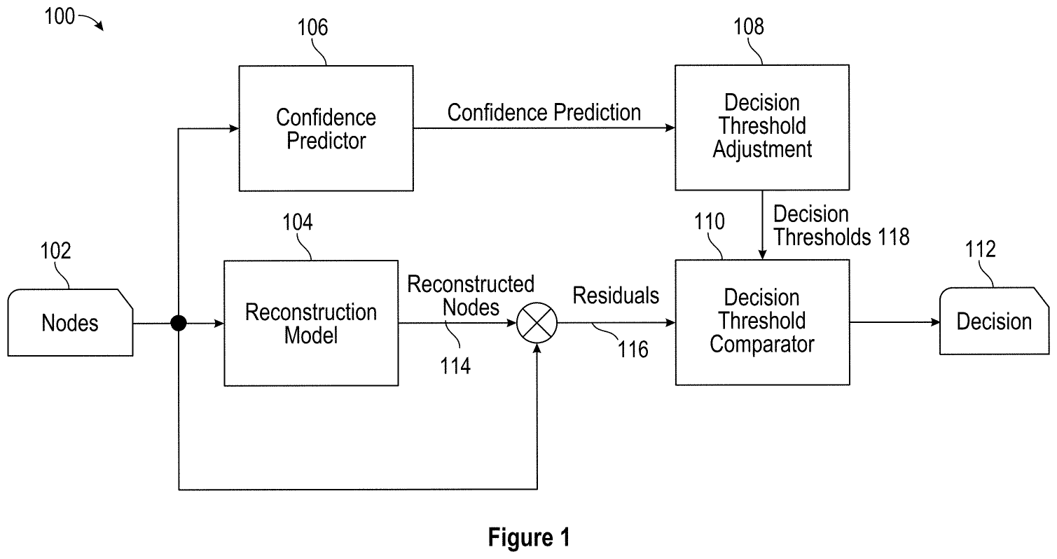

To circumvent this issue, the use of one class classifiers is described in this disclosure for detection of cyber-faults. FIG. 1 shows a block diagram of an example detection system, according to some implementations. At the core of the system lies a reconstruction model 104 that may obtain input dataset from nodes 102 in the form of a windowed dataset and reconstruct the nodes (shown as reconstructed nodes 114) based on the reconstruction model's training on normal datasets. Reconstruction residual 116 would be relatively low if the input dataset resembles normal data that the model 104 is trained on; otherwise, the reconstruction residual 116 would be relatively high. The residuals 116 may then be compared by a decision threshold comparator 110 to suitable decision thresholds 118 to decide whether the datapoint is normal or anomalous (e.g., due to a cyber fault).

A decision threshold adjustment module 108 of the system 100 may feed suitable decision thresholds 118 to the comparator module 110, which may generate the attack/no attack decision 112 for each sample by comparing the decision thresholds 118 to the residuals 116. The nominal decision thresholds are decided based on the distribution of residuals of normal data which are then adapted in real time based on the confidence on reconstruction of that sample.

A confidence predictor module 106 may predict confidence in the accuracy of the decision 112. In some implementations, the confidence predictor module 106 makes the prediction based on the input sample from the nodes 102, the nodes' relative location with respect to the hyperspace spanned by the training data, local sensitivity function of the reconstruction model 104 and the neighborhood of the operating point. The following subsections describe each of the modules in more details.

### Example Reconstruction Model

In some implementations, the reconstruction model 104 is a map [symbol] : [symbol] ^{n×w}→ [symbol] ^{n×w}, which takes as input the windowed data-stream from the nodes X ∈ [symbol] ^{n×w}, where n is the number of nodes and w is the window length, compresses them to a feature space [symbol] ∈ [symbol] ^{m}, m<<n×w, and then reconstructs the windowed input back to \tilde{X} ∈ [symbol] ^{n×w} from the latent features ƒ ∈ [symbol] . [symbol] may be a combination of a compression map [symbol] : [symbol] ^{n×w}→ [symbol] ^{m} and a generative map [symbol] : [symbol] ^{m}→ [symbol] ^{n×w}. During training, [symbol] exploits the features in the normal data to learn the most effective way to compress X to [symbol] and reconstruct \tilde{X} from [symbol] simultaneously by solving the optimization problem

$${arg min}_{𝓅 , ℋ} {‖ \tilde{X} - ℋ ( 𝓅 ( X ) ) ‖}_{k} .$$

Because the compression and generation may be learnt on normal data only, any sample whose feature correlation does not resemble that of the normal dataset would have a relatively high reconstruction error. Any mapping into the feature space that is reversable can be used within this framework. For example, models like deep autoencoder, GAN or a combination of PCA-inverse PCA may serve as the model [symbol] with different degrees of accuracy. For small number of nodes and where the correlation between nodes are primarily linear, a PCA-inverse PCA may be used for quick training and deployment. Here nodes can be either sensor or actuators which have a data stream attached thereto. However, as the number of nodes increase and the correlation becomes more complex, a deep neural network-based model like an autoencoder or GAN may be used, especially when a lot of data is available. Autoencoder or GAN may also have the advantage of being amenable to automated machine learning for rapid training and deployment on high volume of data and scalable across number of nodes and/or assets.

Here, note that [symbol] can either be a monolithic model or an ensemble model, where the constituent models would be trained on different suitable subsets of the normal data. The reconstruction in that case is given by \tilde{X}=Σⱼ₌₁^{p} αⱼ [symbol] ⱼ(X), where [symbol] ⱼ are the respective constituent reconstruction models for j=1,2, . . . , p, and αⱼ is the corresponding weighting factor. Note that the vector α̅=[α₁ α₂ . . . αₚ] may not be constant but determined by the location of the particular X in the operating regime. This kind of ensemble model may be used in scenarios where a single monolithic model cannot provide a small enough reconstruction error over the entire normal operating regime. The constituent regimes can be decided either by data-driven methods or physics knowledge of the system or a combination of both. Physics-based knowledge may guide training separate models for the steady state (or different kinds of steady states) and transients (or different kinds of transients, e.g., fast rising, slow rising, fast falling, slow falling, or in general by separating transients by thresholding the slew rates) to ensure reconstruction error for each constituent model remains low enough. Data driven methods may look at clusters of reconstruction errors and iteratively partition the input space until all the clusters have low enough reconstruction errors.

During operation, a preprocessing module may determine the location of the input X with respect to the training subspaces of the constituent models, which in turn may decide the elements of the weighting vector α̅. Assets with significant variation in feature space [symbol] for a monolithic model would benefit substantially by employing the ensemble technique appropriately.

### Example Confidence Predictor

The confidence of reconstruction (e.g., using the reconstruction model 104), which is essentially an indication of its accuracy, may vary depending on various cases even in normal conditions. Accordingly, it may be important to adjust decision thresholds (used in deciding whether a datapoint is normal or anomalous) accordingly so that an optimum balance between FPR and TPR are maintained. Most common reasons for variation in confidence may include local model sensitivity, model uncertainty, and extrapolation, discussed below. The following subsections describe how some implementations tackle each of these cases. In some implementations, hardened sensors (if available) are used as an additional source of confidence. Hardened sensors are sensors that are physically made secure by using additional redundant hardware.

Local model sensitivity: In some implementations in which the reconstruction model 104 is a highly nonlinear model, the sensitivity of the model will vary based on its operating point. Assuming a stationary output noise, higher sensitivity regions would be more capable in resolving a smaller difference, thus making the reconstructions more accurate. The sensitivity of the model as a function of input space can be computed beforehand or online and may be an indicator of the reconstruction confidence.

Model uncertainty: Depending on sparsity of training data in certain regions, the accuracy of reconstruction may vary. Based on the training set, the uncertainty may be precomputed and serve as a second indicator of the reconstruction confidence.

Extrapolation: During deployment, the reconstruction model 104 may see data points which fall outside the training boundary. The reconstruction accuracy is expected to be lower in those regions and a suitable metric denoting the statistical distance of such a datapoint from the training boundary may serve as a confidence metric or another indicator of the reconstruction confidence.

Some implementations designate boundary conditions and/or hardened sensors to decide the location of the sample with respect to the training set. In absence of that, all attacks would likely be classified as a sparse region/extrapolation from training set. If most of the attacks are accompanied by lower confidence predictions, they would be evaluated against relaxed thresholds, leading to a lower TPR. Some implementations design the confidence metric to avoid this undesirable scenario.

### Example Decision Threshold Adjustment

The decision thresholds 118 are an important component in the whole system to categorize a sample as a normal datapoint or an attack (or cyber fault) datapoint. If the decision thresholds 118 are set too low, then the FPR would be high as some of the noise in the normal data would be categorized as attacks. Conversely, a high decision threshold would amount to missing certain attacks of small magnitudes. Thus, tuning the decision thresholds 118 for optimal TPR/FPR metric may provide more accurate decisions.

The nominal decision threshold vector t̅_{N}=[t₁ t₂ . . . tₚ] may be constituted by taking the 99^{th} percentile point tᵢ of the residual rᵢ of the reconstruction from normal data on the node i. During operation, the value of the scalar valued decision function h(β̅, r̅, t̅_{N}) determines the categorization of the sample as attack or normal, where r̅=[r₁ r₂ . . . rₚ] is the residual vector and β̅=[β₁ β₂ . . . βₚ] is the threshold adaptation vector. A good choice for h is a suitable norm of the order k of the decision vector d̅=[d₁d₂ . . . dₚ], where dᵢ=|rᵢ−βᵢtᵢ|.

In various implementations, the threshold adaptation vector β̅ is either adjusted automatically in real time based on the output of the confidence predictor 106 or in absence of a confidence predictor, chosen based on the reliability operator characteristic (ROC) curve for an optimal TPR/FPR ratio and kept constant over a period of time.

### Example Decision Playback Capability/Two Tier Decision

Depending on the usage scenario, FPR can have a varied requirement. If the end goal is to raise an alarm/flag to alert an operator, some delay can be tolerated between the attack and decision to keep the false alarm rate low. On the other hand, if the decision is to be fed back to a cyber-fault neutralization systems, then a delay in decision communication may jeopardize the stability of the whole system. In such cases, it might be beneficial to start feeding back the decisions 112 as they come in even at the expense of a slightly higher FPR so that the automated downstream system is engaged. Suppose a first tier relays decisions based on single samples. This may have a higher FPR, but a lower detection delay. A second tier may relay decisions after a persistence window. This will help reduce the FPR of the first tier, while appropriately letting mechanisms engage without delay. If the second tier confirms the decision at the end of the persistence period, the downstream system would remain engaged with probably an additional visual alarm/flag (thus enabling playback in the past) and disengage otherwise.

### Example Advantages

The techniques described above are amenable to AutoML paradigm, making it easier and faster to train, update and deploy the reconstruction models. The scalable architecture makes it suitable for both unit level and fleet level deployment. As described above, the model is trained only on field data (no simulation model needed) which in turn makes it suitable to be deployed on assets from other manufacturers.

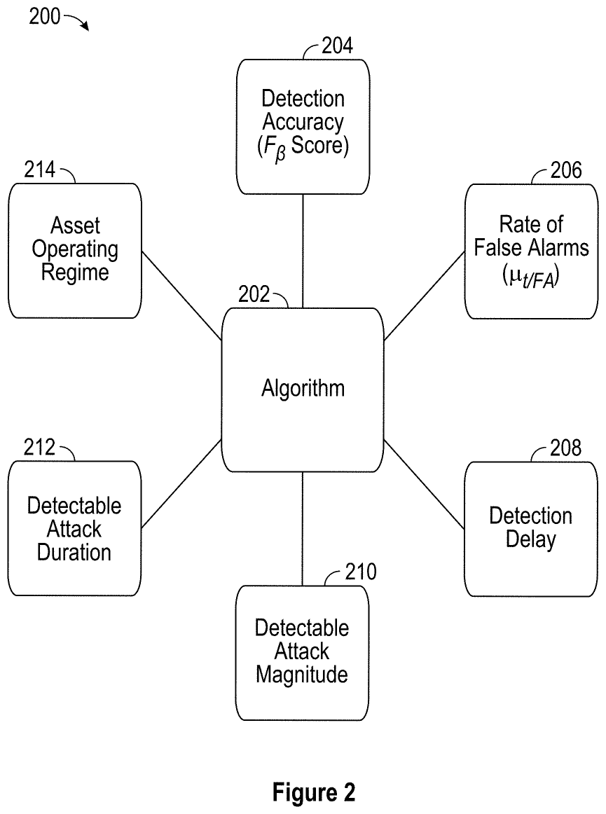

FIG. 2 is a schematic showing various components of a system 200 for detecting cyber-faults in industrial assets, according to some implementations. The algorithm 202 implemented by the system 100 may include parameters for detection accuracy 204, rate of false alarms 206, detection delay 208, detectable attack magnitude 210, detectable attack duration 212, and asset operating regime 214, according to various implementations. One or more of these parameters can affect the algorithm. For example, one parameter can be traded off for others, and the parameters may have varied impact on the output, processing time, accuracy, etc. Typically, any parameter that increases TPR will increase FPR and vice versa. That is why an F_beta score is needed. For example, detectable attack duration may lower limit on how small an attack needs to be detected affects FPR, TPR; the smaller the limit, lower the TPR and higher the FPR. For lower limit on detectable attack magnitude, lower the limit, lower the TPR, and higher the FPR. And, for detection delay, higher the delay, lower the FPR, higher the TPR and higher the chances of leading to system instability.

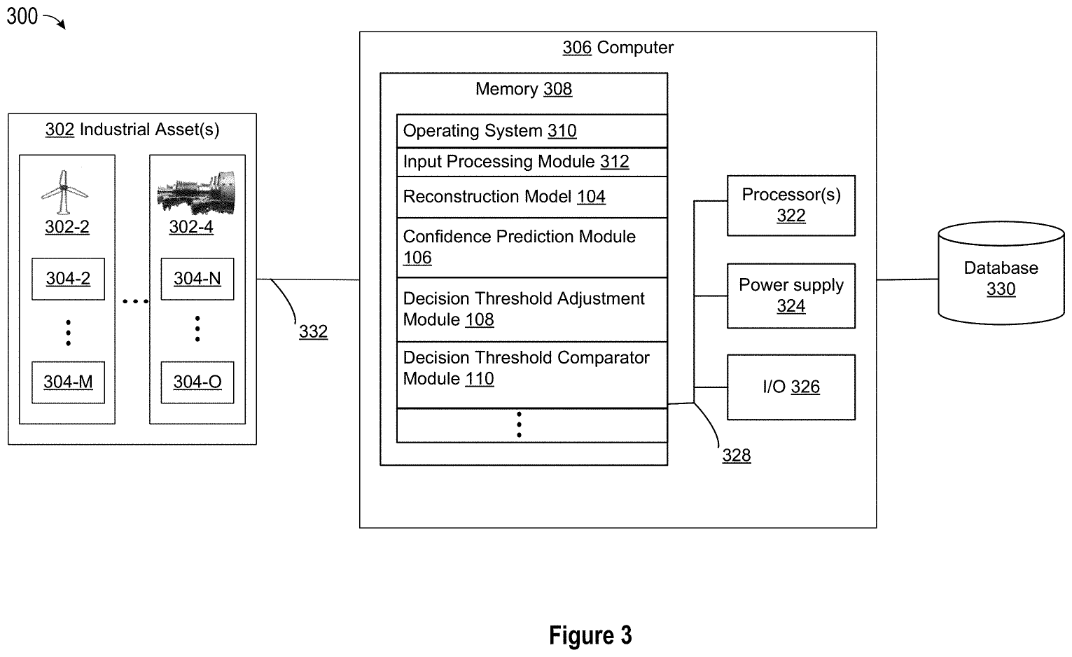

FIG. 3 is a block diagram of an example system 300 for detecting cyber-faults in industrial assets, according to some implementations. The system 300 includes one or more industrial assets 302 (e.g., a wind turbine engine 302-2, a gas turbine engine 302-4) that include nodes 304 (e.g., the nodes 102, nodes 304-2, . . . , 304-M, and nodes 304-N, . . . , 304-O). In practice, the industrial assets 302 may include an asset community including several industrial assets. It should be understood that wind turbines and gas turbine engines are merely used as non-limiting examples of types of assets that can be a part of, or in data communication with, the reset of the system 300. Examples of other assets include steam turbines, heat recovery steam generators, balance of plant, healthcare machines and equipment, aircraft, locomotives, oil rigs, manufacturing machines and equipment, textile processing machines, chemical processing machines, mining equipment, and the like. Additionally, the industrial assets may be co-located or geographically distributed and deployed over several regions or locations (e.g., several locations within a city, one or more cities, states, countries, or even continents). The nodes 304 may include sensors, actuators, controllers, software nodes. The nodes 304 may not be physically co-located or may be communicatively coupled via a network (i.e., wired or wireless network, such as an IoT over 5G, 6G or Wi-Fi 6). The industrial assets 302 are communicatively coupled to a computer 306 via communication link(s) 332 that may include wired or wireless communication network connections, such as an IoT over 5G/6G or Wi-Fi 6.

The computer 306 typically includes one or more processor(s) 322, a memory 308, a power supply 324, an input/output (I/O) subsystem 326, and a communication bus 328 for interconnecting these components. The processor(s) 322 execute modules, programs and/or instructions stored in the memory 308 and thereby perform processing operations, including the methods described herein.

In some implementations, the memory 308 stores one or more programs (e.g., sets of instructions), and/or data structures, collectively referred to as “modules” herein. In some implementations, the memory 308, or the non-transitory computer readable storage medium of the memory 308, stores the following programs, modules, and data structures, or a subset or superset thereof:
an operating system 310;
an input processing module 312 that accepts signals or input datasets from the industrial assets 302 via the communication link 332. In some implementations, the input processing module accepts raw inputs from the industrial assets 302 and prepares the data for processing by other modules in the memory 308;
the reconstruction model 104;
the confidence predictor module 106;
the decision threshold adjustment module 108; and
the decision threshold comparator module 110.

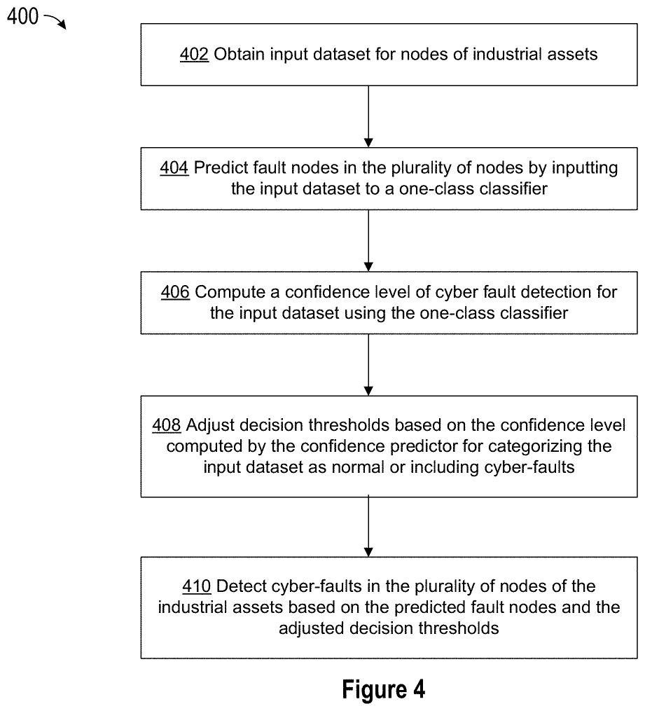

Details of operations of the above modules are described above in reference to FIGS. 1 and 2, and further described below in reference to FIG. 4, according to some implementations.

The above identified modules (e.g., data structures, and/or programs including sets of instructions) need not be implemented as separate software programs, procedures, or modules, and thus various subsets of these modules may be combined or otherwise re-arranged in various implementations. In some implementations, the memory 308 stores a subset of the modules identified above. In some implementations, a database 330 (e.g., a local database and/or a remote database) stores one or more modules identified above and data (e.g., decisions 112) associated with the modules. Furthermore, the memory 308 may store additional modules not described above. In some implementations, the modules stored in the memory 308, or a non-transitory computer readable storage medium of the memory 308, provide instructions for implementing respective operations in the methods described below. In some implementations, some or all of these modules may be implemented with specialized hardware circuits that subsume part or all of the module functionality. One or more of the above identified elements may be executed by the one or more of processor(s) 322.

The I/O subsystem 326 communicatively couples the computer 306 to any device(s), such as servers (e.g., servers that generate reports), and user devices (e.g., mobile devices that generate alerts), via a local and/or wide area communications network (e.g., the Internet) via a wired and/or wireless connection. Each user device may request access to content (e.g., a webpage hosted by the servers, a report, or an alert), via an application, such as a browser. In some implementations, output of the computer 306 (e.g., decision 112 generated by the decision threshold comparator module 110) is communicated to a control system that controls the nodes 102 of the industrial assets 302.

The communication bus 328 optionally includes circuitry (sometimes called a chipset) that interconnects and controls communications between system components.

FIG. 4 shows a flowchart of an example method 400 for detecting cyber-faults in industrial assets, according to some implementations. The method 400 can be executed on a computing device (e.g., the computer 306) that is connected to industrial assets (e.g., the assets 302). The method includes obtaining (402) an input dataset (e.g., using the input processing module 312) from a plurality of nodes (e.g., the nodes 304, such as sensors, actuators, or controller parameters; the nodes 102 may be physically co-located or connected through a wired or wireless network (in the context of IoT over 5G, 6G or Wi-Fi 6)) of industrial assets. The method also includes predicting (404) a fault node in the plurality of nodes by inputting the input dataset to a one-class classifier (e.g., using the reconstruction model 104). The one-class classifier is trained on normal operation data (e.g., historical field data or simulation data) obtained during normal operations (e.g., no cyber-attacks) of the industrial assets. The method also includes computing (406) a confidence level (e.g., using the confidence predictor module 106) of cyber fault detection for the input dataset using the one-class classifier. The method also includes adjusting (408) a decision threshold (e.g., using the decision threshold adjustment module 108) based on the confidence level computed by the confidence predictor for categorizing the input dataset as normal or including a cyber-fault. The method also includes detecting (410) the cyber-fault in the plurality of nodes of the industrial assets (e.g., using the decision threshold comparator module 110) based on the predicted fault node and the adjusted decision threshold.

In some implementations, the method further includes computing reconstruction residuals (e.g., using the reconstruction model 104) for the input dataset such that the residual is low if the input dataset resembles the normal operation data, and high if the input dataset does not resemble the historical field data or simulation data. Detecting cyber-faults in the plurality of nodes includes comparing the decision thresholds to the reconstruction residuals (e.g., using the decision threshold comparator module 110) to determine if a datapoint in the input dataset is normal or anomalous.

In some implementations, the one-class classifier is a reconstruction model (e.g., a deep autoencoder, a GAN, or a combination or PCA-inverse PCA, depending on the number of nodes) configured to reconstruct nodes of the industrial assets from the input dataset, using (i) a compression map that compresses the input dataset to a feature space, and (ii) a generative map that reconstructs the nodes from latent features of the feature space. In some implementations, the reconstruction model is a map [symbol] : [symbol] ^{n×w}→ [symbol] ^{n×w} that obtains windowed data-stream from the nodes X ∈ [symbol] ^{n×w}. n is the number of nodes and w is the window length. n can be a few nodes to several hundred nodes depending on the asset; for w, depending on the asset dynamics and sampling rate, it can be a few tens to a few thousands. The compression map is a map [symbol] : [symbol] ^{n×w}→ [symbol] ^{m} that compresses the windowed data-stream to a feature space [symbol] ∈ [symbol] ^{m}, m<<n×w, where m is the latent space, and the generative map is a map [symbol] : [symbol] ^{m}→ [symbol] ^{n×w} that reconstructs the windowed input back to \tilde{X} ∈ [symbol] ^{n×w} from the latent features ƒ ∈ [symbol] . In some implementations, the reconstruction model [symbol] compresses X to [symbol] and reconstruct \tilde{X} from [symbol] simultaneously by solving the optimization problem

$${arg min}_{𝓅 , ℋ} {‖ \tilde{X} - ℋ ( 𝓅 ( X ) ) ‖}_{k} .$$

n is the number of nodes. Latent features are a projection of the dataset to a lower dimensional space. Typically, this also includes an inverse projection to reconstruct the dataset from the latent space. A simple example of latent space is the eigenvectors of a matrix. PCA/f-PCA is another example of a linear projection to latent space. Autoencoder/GAN are examples of nonlinear projections to latent space. Since latent space dimension m<<n×w, any projection that satisfies this constraint will compress the n×w, dataset to m dimensions.

In some implementations, the one-class classifier (or a suitably designed or adapted anomaly detector) is an ensemble of reconstruction models, and each reconstruction model of the ensemble is trained on different operating regimes or boundary conditions of the input dataset. The confidence prediction and other methods to improve the accuracy of the classifier is not limited to one-class classifiers, and can be applied to traditional two-class or multi-class methods as well. In some implementations, the reconstruction is computed using the equation \tilde{X}Σⱼ₌₁^{p} αⱼ [symbol] ⱼ(X). [symbol] ⱼ are the respective constituent reconstruction models for j=1,2, . . . , p, αⱼ is the corresponding weighting factor, and the vector α̅=[α₁ α₂ . . . αₚ] is determined by the location of the particular X input in the operating regimes. In a pure data based settings, neighborhoods has to be identified by suitable clustering algorithms. Similarly, the importance of the clusters and associated weights need to be derived based on their ‘size’, occurrence, prevalence and similar metrics. During operation, a preprocessing module determines the location of the input X with respect to the training subspaces of the constituent models, which in turn decides the elements of the weighting vector α̅. Assets with significant variation in feature space [symbol] for a mono-lithic model would benefit substantially by employing the ensemble technique appropriately). Assets with significant variations include any asset that has very different transient signatures from steady state signatures. There might be further classifications of transients (rising/falling). In some implementations, the operating regimes are determined based on physical characteristics of the industrial assets or using data driven methods. In some implementations, the physical characteristics are used for training separate models for the steady state or different kinds of steady states and transients or different kinds of transients (e.g., fast rising, slow rising, fast falling, slow falling, or in general by separating transients by thresholding the slew rates) in order to ensure reconstruction error for each constituent model remains below a predetermined threshold. In some implementations, the data driven methods computes clusters of reconstruction errors (e.g., computed using different unsupervised techniques like GMM, k_means, DBSCAN) for normal operating conditions and uses the clusters to iteratively partition the input space (i.e., all possible inputs) until all the clusters have reconstruction errors below a predetermined threshold (e.g., a key performance indicator or KPI of the particular system).

In some implementations, computing the confidence level of cyber fault detection (e.g., using the confidence prediction module 106) includes computing model sensitivity of the one-class classifier for the input dataset. In some implementations, the one-class classifier is a reconstruction model that is a nonlinear model. The model sensitivity varies based on operating points, and higher sensitivity regions are more capable than lower sensitivity regions in resolving a smaller difference, thereby making the reconstruction more accurate (as the reconstruction model is a highly nonlinear model, the sensitivity of the model will vary based on its operating point. Assuming a stationary output noise, higher sensitivity regions would be more capable in resolving a smaller difference, thus making the reconstructions more accurate). Higher sensitivity and lower sensitivity are relative terms and may be defined by the KPI of the system. For example, 1% may be small in one application, whereas the same value may be unacceptably large in another depending on the KPI.

In some implementations, computing the confidence level of cyber fault detection (e.g., using the confidence prediction module 106) includes computing model uncertainty of the one-class classifier for the input dataset based on sparsity of training dataset used to train the one-class classifier. Depending on sparsity of training data in certain regions, the accuracy of reconstruction may vary. Based on the training set, the uncertainty may be precomputed and serve as a second indicator of confidence predictor.

In some implementations, computing the confidence level of cyber fault detection (e.g., using the confidence prediction module 106) includes computing statistical distance or L2 distance in an n-space of the input dataset from a training dataset used to train the one-class classifier. For extrapolation, during deployment, the reconstruction model is bound to see data points which falls outside the training boundary. The reconstruction accuracy is expected to be lower in those regions and a suitable metric denoting the statistical distance of the said datapoint from the training boundary will serve as a confidence metric.

In some implementations, the method further includes: designating boundary conditions (e.g., ambient conditions) and/or hardened sensors to compute location of the input dataset with respect to a training dataset used to train the one-class classifier, for computing the confidence level of cyber fault detection using the one-class classifier. In absence of that, all attacks would likely be classified as a sparse region or extrapolation from training set. If most of the attacks are accompanied by lower confidence predictions, they would be evaluated against relaxed thresholds, leading to a lower TPR. As described above, hardened sensors are physically made secure by using additional redundant hardware. The probability that those sensors are attacked is very low. Some implementations determine the confidence metric so as to avoid this undesirable scenario.

In some implementations, the method further includes computing an adaptive decision threshold (e.g., using the decision threshold adjustment module 108) for each node of the plurality of nodes based on a predetermined percentile (e.g., the 99th percentile, or an appropriate percentile value depending on a KPI of the system) of a corresponding residual of the one-class classifier for normal data on the respective node. In some implementations, computing the adaptive decision threshold includes: computing a nominal decision threshold vector t̅ₙ=[t₁ t₂ . . . tₚ] using the 99^{th} percentile point tᵢ of residual rᵢ of reconstruction of a node i using normal data on the node i, wherein the plurality of nodes includes p nodes; and categorizing the input dataset as cyber fault or normal based on the value of a scalar valued decision function h(β̅, r̅, t̅_{N}), wherein and r̅=[r₁ r₂ . . . rₚ] is a residual vector, and β̅=[β₁ β₂ . . . βₚ] is a threshold adaptation vector. In some implementations, the scalar valued decision function h is a norm of the order k of a decision vector d̅=[d₁d₂ . . . dₚ], where dᵢ=|rᵢ−βᵢtᵢ|. The decision function need not be scalar valued, and a scalar valued decision function is a simple example of decision function. In some implementations, the threshold adaptation vector β̅ is adjusted based on the confidence level of cyber-fault detection. In some implementations, the method further includes adjusting the threshold adaptation vector β̅ after each predetermined time period. The time period may be changed for each sample, although the algorithm may take longer to converge. In some implementations, the threshold adaptation vector β̅ is selected based on the Receiver Operating Characteristic (ROC) curve for an optimal ratio of a True Positive Rate over a False Positive Rate. In some implementations, the method further includes selecting the False Positive Rate based on a delay tolerance level for detecting the cyber-faults. The tolerance level may be based on a KPI of the system. For example, for a gas turbine engine, the value cmay be set at 15 samples. In some implementations, the method further includes: selecting a low value of the False Positive Rate if the delay tolerance level for detecting the cyber-faults is high. Depending on the usage of the detection module, FPR can have a varied requirement. If the end goal is to raise an alarm/flag to alert an operator, some delay can be tolerated between the attack and decision to keep the false alarm rate low. In some implementations, the method further includes selecting a high value of the False Positive Rate if the delay tolerance level for detecting the cyber-faults is low. On the other hand, if the decision is to be fed back to a cyber-fault neutralization systems (e.g., as described in U.S. Pat. No. 10,771,495, which is incorporated herein by reference), then a delay in decision communication may jeopardize the stability of the whole system. In such cases, it might be beneficial to start feeding back the decisions as they come in even at the expense of a slightly higher FPR so that the automated downstream system is engaged.

In some implementations, the method further includes generating an alarm (e.g., using the decision threshold comparator module 110 or a separate module for generating alerts) that alerts an operator of the industrial assets based on the detected cyber-faults.

In some implementations, the method further includes transmitting (e.g., using the decision threshold comparator module 110) the detected cyber-faults to a cyber fault neutralization system configured to neutralize the detected cyber-faults in the industrial assets. In some implementations, the method further includes monitoring the industrial assets to determine if the detected cyber-faults persist after a predetermined time period; and in accordance with a determination that the detected cyber-faults persist after the predetermined time period, causing the cyber fault neutralization system to continue to neutralize the detected cyber-faults. The persistence period may be set based on a KPI of the system, and may determine the detection delay (e.g., 15 samples for a gas turbine). In some implementations, the method further includes in accordance with a determination that the detected cyber-faults persist after the predetermined time period, continuing to transmit the detected cyber-faults to a cyber-fault neutralization system, wherein the cyber-fault neutralization system is further configured to playback the transmitted detected cyber-faults and to determine if it is required to continue to neutralize the detected cyber-faults.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations are chosen in order to best explain the principles underlying the claims and their practical applications, to thereby enable others skilled in the art to best use the implementations with various modifications as are suited to the particular uses contemplated.

What is claimed is:

1. A computer-implemented method for detecting cyber-faults in industrial assets, the method comprising:
obtaining an input dataset from a plurality of nodes of industrial assets, wherein the plurality of nodes are physically co-located or connected through a wired or wireless network;
predicting a fault node in the plurality of nodes by inputting the input dataset to a one-class classifier, wherein the one-class classifier is trained on normal operation data obtained during normal operations of the industrial assets;
computing a confidence level of cyber fault detection for the input dataset using the one-class classifier;
adjusting a decision threshold based on the confidence level for categorizing the input dataset as normal or including a cyber-fault; and
detecting the cyber-fault in the plurality of nodes of the industrial assets based on the predicted fault node and the adjusted decision threshold.

2. The method of claim 1, further comprising:
computing a reconstruction residual for the input dataset,
wherein detecting the cyber-fault in the plurality of nodes comprises comparing the decision threshold to the reconstruction residual to determine if a datapoint in the input dataset is normal or anomalous.

3. The method of claim 1, wherein the one-class classifier is a reconstruction model configured to reconstruct nodes of the industrial assets from the input dataset, using (i) a compression map that compresses the input dataset to a feature space, and (ii) a generative map that reconstructs the nodes from latent features of the feature space.

4. The method of claim 3, wherein the reconstruction model is a map [symbol] : [symbol] ^{n×w}→ [symbol] ^{n×w} that obtains windowed data-stream from the nodes X ∈ [symbol] ^{n×w}, wherein n is the number of nodes and w is the window length, wherein the compression map is a map [symbol] : [symbol] ^{n×w}→ [symbol] ^{m} that compresses the windowed data-stream to a feature space [symbol] ∈ [symbol] ^{m}, m<<n×w, and wherein the generative map is a map [symbol] : [symbol] ^{m}→ [symbol] ^{n×w} that reconstructs the windowed input back to \tilde{X} ∈ [symbol] ^{n×w} from the latent features ƒ ∈ [symbol] .

5. The method of claim 4, wherein the reconstruction model [symbol] compresses X to [symbol] and reconstruct \tilde{X}from [symbol] simultaneously by solving the optimization problem
$${arg min}_{𝓅 , ℋ} {‖ \tilde{X} - ℋ ( 𝓅 ( X ) ) ‖}_{k} .$$

6. The method of claim 1, wherein the one-class classifier is an ensemble of reconstruction models, and wherein each reconstruction model of the ensemble is trained on different operating regimes or boundary conditions of the input dataset.

7. The method of claim 6, wherein the reconstruction is computed using the equation \tilde{X}=Σⱼ₌₁^{p} αⱼ [symbol] ⱼ(X), wherein [symbol] ⱼ are the respective constituent reconstruction models for j=1,2, . . . , p, αⱼ is the corresponding weighting factor, and the vector α̅=[α₁ α₂ . . . αₚ] is determined by the location of the particular X input in the operating regimes.

8. The method of claim 7, where the operating regimes are determined based on physical characteristics of the industrial assets or using data driven methods.

9. The method of claim 8, wherein the physical characteristics are used for training separate models for the steady state or different kinds of steady states and transients or different kinds of transients in order to ensure reconstruction error for each constituent model remains below a predetermined threshold.

10. The method of claim 8, wherein the data driven methods compute clusters of reconstruction errors for normal operating conditions and use the clusters to iteratively partition the input space until all the clusters have reconstruction errors below a predetermined threshold.

11. The method of claim 1, wherein computing the confidence level of cyber fault detection comprises computing model sensitivity of the one-class classifier for the input dataset.

12. The method of claim 11, wherein the one-class classifier is a reconstruction model that is a nonlinear model, wherein the model sensitivity varies based on operating points, and wherein higher sensitivity regions are more capable than lower sensitivity regions in resolving a smaller difference, thereby making the reconstruction more accurate.

13. The method of claim 1, wherein computing the confidence level of cyber fault detection comprises computing model uncertainty of the one-class classifier for the input dataset based on sparsity of training dataset used to train the one-class classifier.

14. The method of claim 1, wherein computing the confidence level of cyber fault detection comprises computing statistical distance or L2 distance in an n-space of the input dataset from a training dataset used to train the one-class classifier.

15. The method of claim 1, further comprising:
designating boundary conditions and/or hardened sensors to compute location of the input dataset with respect to a training dataset used to train the one-class classifier, for computing the confidence level of cyber fault detection using the one-class classifier.

16. The method of claim 1, further comprising:
computing an adaptive decision threshold for each node of the plurality of nodes based on a predetermined percentile of a corresponding residual of the one-class classifier for normal data on the respective node.

17. The method of claim 16, wherein computing the adaptive decision threshold comprises:
computing a nominal decision threshold vector t̅ₙ[t₁ t₂ . . . tₚ] using the 99^{th} percentile point tᵢ of residual rᵢ of reconstruction of a node i using normal data on the node i, wherein the plurality of nodes includes p nodes; and
categorizing the input dataset as cyber fault or normal based on the value of a scalar valued decision function h(β̅, r̅, t̅_{N}), wherein and r̅=[r₁ r₂ . . . rₚ] is a residual vector, and β̅=[β₁ β₂ . . . βₚ] is a threshold adaptation vector.

18. The method of claim 17, wherein the scalar valued decision function h is a norm of the order k of a decision vector d̅=[d₁d₂. . . dₚ], where dᵢ=|rᵢ−βᵢtᵢ|.

19. The method of claim 17, wherein the threshold adaptation vector β̅ is adjusted based on the confidence level of cyber-fault detection.

20. The method of claim 19, further comprising:
adjusting the threshold adaptation vector β̅ after each predetermined time period.

21. The method of claim 17, wherein the threshold adaptation vector β̅ is selected based on the Receiver Operating Characteristic (ROC) curve for an optimal ratio of a True Positive Rate over a False Positive Rate.

22. The method of claim 20, further comprising:
selecting the False Positive Rate based on a delay tolerance level for detecting the cyber-faults.

23. The method of claim 1, further comprising:
generating an alarm that alerts an operator of the industrial assets based on the detected cyber-faults.

24. The method of claim 1, further comprising:
transmitting the detected cyber-faults to a cyber fault neutralization system configured to neutralize the detected cyber-faults in the industrial assets.

25. The method of claim 26, further comprising:
monitoring the industrial assets to determine if the detected cyber-faults persist after a predetermined time period; and
in accordance with a determination that the detected cyber-faults persist after the predetermined time period, causing the cyber fault neutralization system to continue to neutralize the detected cyber-faults.

26. The method of claim 27, further comprising:
in accordance with a determination that the detected cyber-faults persist after the predetermined time period, continuing to transmit the detected cyber-faults to a cyber-fault neutralization system, wherein the cyber-fault neutralization system is further configured to playback the transmitted detected cyber-faults and to determine if it is required to continue to neutralize the detected cyber-faults.

27. A system for detecting cyber-faults in industrial assets, comprising:
one or more processors;
memory; and
one or more programs stored in the memory, wherein the one or more programs are configured for execution by the one or more processors and include instructions for:
obtaining an input dataset from a plurality of nodes of industrial assets;
predicting a fault node in the plurality of nodes by inputting the input dataset to a one-class classifier, wherein the one-class classifier is trained on normal operation data obtained during normal operations of the industrial assets;
computing a confidence level of cyber fault detection for the input dataset using the one-class classifier;
adjusting a decision threshold based on the confidence level for categorizing the input dataset as normal or including a cyber-fault; and
detecting the cyber-fault in the plurality of nodes of the industrial assets based on the predicted fault nodes and the adjusted decision threshold.

28. A non-transitory computer-readable storage medium storing one or more programs for execution by one or more processors of an electronic device, the one or more programs including instructions for:
obtaining an input dataset from a plurality of nodes of industrial assets;
predicting a fault node in the plurality of nodes by inputting the input dataset to a one-class classifier, wherein the one-class classifier is trained on normal operation data obtained during normal operations of the industrial assets;
computing a confidence level of cyber fault detection for the input dataset using the one-class classifier;
adjusting a decision threshold based on the confidence level for categorizing the input dataset as normal or including a cyber-fault; and
detecting the cyber-fault in the plurality of nodes of the industrial assets based on the predicted fault nodes and the adjusted decision threshold.
